(19) United States
(12) Patent Application Publication
(10) Pub. No.: US 2004/0188874 A1
(43) Pub. Date: Sep. 30, 2004

(54) Method and equipment for producing antiglare and antireflection film and antiglare and antireflection film

(75) Inventors: Shinji Hikita, Minami-Ashigara-shi (JP); Tadashi Hayashi, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/809,872

(22) Filed: Mar. 26, 2004

(30) Foreign Application Priority Data
Mar. 26, 2003 (JP) 2003-084658

(51) Int. Cl. B29D 7/01; B29D 11/00

(52) U.S. Cl. 264/1.34; 264/1.6; 425/363

(57) ABSTRACT

In the production of an antiglare and antireflection film conducted by nipping antireflection film between an embossing roller and a backup roller to transfer the shape of convexes and concaves formed on the embossing roller to one surface of the antireflection film, the longitudinal elastic modulus and hardness of the backup roller are made smaller than the longitudinal elastic modulus and hardness of the embossing roller.

### BACKGROUND OF THE INVENTION

1. Field of the Invention

The present invention relates to a method and an equipment for producing an antiglare and antireflection film as well as to an antiglare and antireflection film, more specifically the present invention relates to a method and an equipment for producing an antiglare and antireflection film as well as to an antiglare and antireflection film for use in an image display device such as a liquid crystal display device.

2. Description of the Related Art

An antireflection film is provided in various image display devices such as a liquid crystal display (LCD), a plasma display panel (PDP), an electroluminescence display (ELD), a cathode-ray tube display (CRT). As an antireflection film, a multilayer film in which transparent thin films of metal oxides are the laminated has been commonly used. Two or more transparent thin films are used for preventing reflection of the light of various wavelengths. The transparent thin film of a metal oxide is formed by chemical vapor deposition (CVD) method or physical vapor deposition (PVD) method, especially a vacuum deposition method which is a kind of physical vapor deposition method. Although the transparent thin film of a metal oxide has optical characteristics excellent as an antireflection film, formation by vacuum deposition method is low in productivity and is not suitable for mass production. The antireflection film by the PVD method in some applications may be formed on the support base which has antiglare properties due to surface convexes and concaves. Although such a film has a reduced parallel transmittance in comparison with one formed on a smooth support base, surface convexes and concaves scatters and reduces reflect of background to exhibit antiglare properties, which along with the antireflection effect remarkably enhances display quality in an application a display device.

In place of the vacuum deposition method, a method of forming an antireflection film by the application of inorganic particles has been proposed. Japanese Patent Publication No. 60-59250 discloses an antireflection layer having fine pores and particulate inorganic substances. The antireflection layer is formed by coating. The fine pores are formed by activated gas processing conducted after the application of the layer thereby allowing the gas to escape from the layer. Japanese Patent Application Publication No. 59-50401 discloses an antireflection film in which a support base, a high refractive-index layer, and a low refractive-index layer are laminated in this order. This official gazette also discloses an antireflection film provided with a medium refractive-index layer between the support base and the high refractive-index layer. The low refractive-index layer is formed by the application of a polymer or inorganic particles.

As a device to impart antiglare properties to the antireflection film by application or coating as mentioned above, a method of applying an antireflection layer on the support base having surface convexes and concaves, a method of adding mat particles for forming surface convexes and concaves to the coating liquid for forming an antireflection layer, etc. have been explored. The former method, however, causes the coating liquid for forming the antireflection layer to flow from convex portions to concave portions, resulting in unevenness of the film thickness within the surface and gives rise to a problem that antireflective performance is significantly deteriorated as compared with the coated film to a flat and smooth surface. The latter method requires mat particles having a particle size around 1 μm or more to be embedded in the thin film of about 0.1 μm to 0.3 μm in thickness in order to make exhibit sufficient antiglare properties, and the problem of the powder loss by dropout of mat particles will arise.

As a measure to cope with these problems, the applicant of the present application proposed in Japanese Patent Application Publication Nos. 2000-275404 and 2000-329905 a method which does not form an transparent support base having convexes and concaves or adds mat particles to the coating liquid for forming the antireflection layer so as to impart convexes and concaves to the surface of the antireflection layer as in the conventional methods but presses the antireflection film provided with the antireflection layer using a metal embossing roller and a metal backup roller.

However, the method of pressing the antireflection film with an embossing roller and a backup roller has a problem that when the pressure is applied onto the antireflection film, the convex portions of the embossing roller for forming convexes and concaves to the surface of the antireflection layer may penetrate and perforate the antireflection film. This problem may be alleviated by adjusting the pressure of the press but the problem of perforation cannot be completely solved. Moreover if the pressure of the press is reduced so as to ensure the perforation not to occur, transfer accuracy will become extremely impaired.

### SUMMARY OF THE INVENTION

The present invention has been accomplished under these circumstances. An object the present invention is to provide a method and an equipment for producing an antiglare and antireflection film and to provide an antiglare and antireflection film, wherein the surface of the antireflection layer of the antireflection film can be imparted with convexes and concaves by emboss processing without occurring perforation in the antireflection film and with good transfer accuracy.

For the purpose of attaining the above-mentioned object, the present invention provides a method for producing an antiglare and antireflection film, comprising the step of: nipping the antireflection film with an embossing member having a plurality of convexes and concaves and a support member to transfer the shape of convexes and concaves of the embossing member to the surface of the antireflection layer after providing at least one antireflection layer on a transparent support base to form an antireflection film, wherein when the antireflection film is nipped with the embossing member and the support member, the pressure applied on the support member by the convex portions through the antireflection film is dispersed by the support member.

For the purpose of attaining the above-mentioned object, the present invention also provides an equipment for producing an antiglare and antireflection film, comprising: an equipment for forming an antireflection film by providing at least one antireflection layer on a transparent support base to form an antireflection film; and an equipment for transferring which nips the antireflection film with an embossing member and a support member to transfer the shape of convexes and concaves of the embossing member to the surface of the antireflection layer, wherein the support member has a longitudinal elastic modulus or pencil hardness less than the longitudinal elastic modulus or pencil hardness of the embossing member.

For the purpose of attaining the above-mentioned object, the present invention also provides an antiglare and antireflection film which has been produced using the equipment for producing an antiglare and antireflection film of any one of claims 2 to 7.

According to the present invention, when emboss processing by the embossing member and the support member is conducted to impart convexes and concaves to the surface of the antireflection layer of the antireflection film, the support member has a longitudinal elastic modulus or pencil hardness less than the longitudinal elastic modulus or pencil hardness of the embossing member, and as a result, when the antireflection is nipped with the embossing member and the support member, the pressure applied on the support member by the convex portions through the antireflection film can be dispersed by the support member. Since the pressure is thus dispersed, the convex portions of the embossing member do not penetrate the antireflection layer and do not perforate the antireflection film. It should be noted that the support member may be specified so as to satisfy the requirements for both the longitudinal elastic modulus and the pencil hardness.

In an embodiment of the present invention, the support member which supports one side of the antireflection film opposite to the antireflection layer has a longitudinal elastic modulus of not less than 1×10⁴ kgf/cm² and not more than 2.1×10⁶ kgf/cm². The surface layer of the support member has a pencil hardness of 2B or more 7H or less. By specifying the upper limit of the longitudinal elastic modulus of the support member as 2.1×10⁶ kgf/cm² and the upper limit of the pencil hardness of the support member on the surface thereof as 7H, the pressure applied on the support member by the convex portions through the antireflection film can be effectively dispersed by the support member when the antireflection film is nipped with the embossing member and the support member. Furthermore, by specifying the lower limit of the longitudinal elastic modulus of the support member as 1×10⁴ kgf/cm² and the lower limit of the pencil hardness of the support member on the surface thereof as 2B, transfer accuracy is not no adversely effected. The embossing member to be used here may be a pattern plate having a plurality of convexes and concaves formed on the transferring surface, and a flat support member may be arranged opposite to the pattern plate used, but the embossing member may preferably comprised of a pair of nip roller comprising an embossing roller having a plurality of convexes and concaves formed on the roller surface and a backup roller placed opposite thereto from a viewpoint of facilitating fully continuous production.

As another embodiment of the present invention, at least the surface of the embossing member out of the embossing member and the support member is preferably heated to a temperature above the glass transition temperature of the transparent support base with a heating device when the antireflection film is subjected to emboss processing. Since the transparent support base is heated at such a temperature above the glass transition temperature, the impact resistance of the antireflection film is enhanced and prevention of perforation in the antireflection film is further improved.

As is described above, according to the method and equipment for producing an antiglare and antireflection film and to such an antireflection film of the present invention, emboss processing can impart surface convexes and concaves to the surface of the antireflection layer of an antireflection film without causing perforation in the antireflection film and production of an antiglare and antireflection film can be produced with excellent transfer accuracy.

According to the method and the equipment for producing an antiglare and antireflection film and the antiglare and antireflection film of the present invention, the surface of the antireflection layer of the antireflection film can be imparted with convexes and concaves by emboss processing without occurring perforation in the antireflection film and with good transfer accuracy.

### BRIEF DESCRIPTION OF THE DRAWINGS

FIG. 1 is a diagram showing the whole constitution of the equipment for producing an antiglare and antireflection film of the present invention;

FIG. 2 is a perspective view of transfer equipment in the equipment for producing an antiglare and antireflection composed of an embossing roller and a backup roller;

FIG. 3 illustrates the convex-concave shape transferred to the antireflection film by the transfer equipment;

FIG. 4A and FIG. 4B illustrate the convex-concave shape formed on the embossing roller of the transfer equipment;

FIG. 5 illustrates the function of the present invention at the time of transfer; and

FIG. 6 is a schematic view showing another embodiment of the transfer equipment composed of a pattern plate and a support member.

### DETAILED DESCRIPTION OF THE PREFERRED EMBODIMENTS

Preferred embodiments of the method and equipment for producing an antiglare and antireflection film, and the antiglare and antireflection film according to the present invention will now be described in detail following the appended drawings.

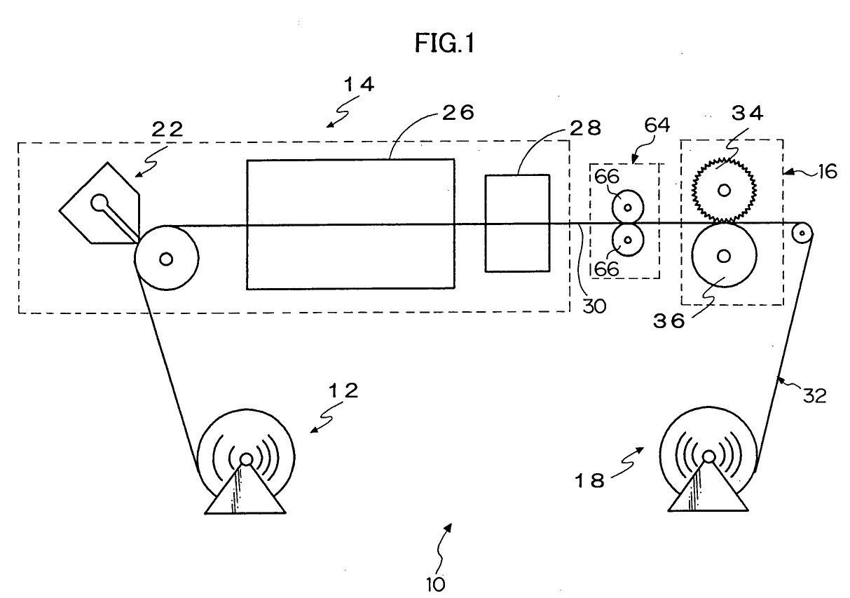

FIG. 1 is a diagram showing the whole constitution of the equipment 10 for producing an antiglare and antireflection film of the present invention, and mainly composed of let-off equipment 12, antireflection film forming equipment 14, transfer equipment 16 and rolling-up equipment 18.

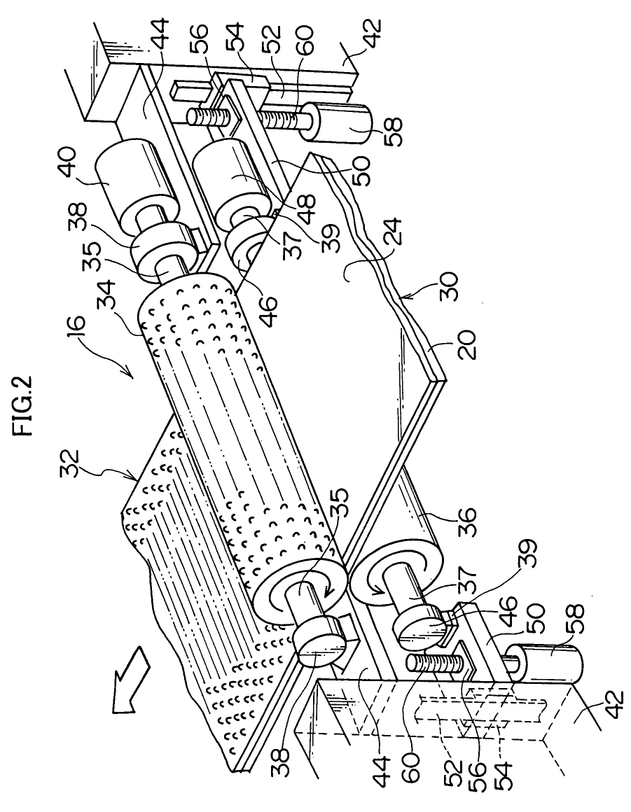

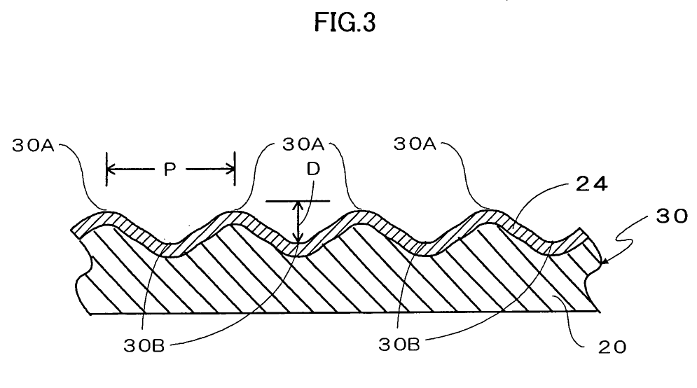

The antireflection film forming equipment 14 applies an antireflection layer 24 (See FIGS. 2 and 3) to the transparent support base 20 sent out from the let-off equipment 12 with the coating equipment 22, and after the antireflection layer 24 is dried with a drying equipment 26, the antireflection layer 24 is cured with a curing equipment 28 by heat treatment or ultraviolet ray irradiation. Thereby, the antireflection film 30 is formed. The antireflection layer 24 may be, in this case, one-layer structure of a low refractive-index layer, two-layer structure having a high refractive-index layer between the low refractive-index layer and the transparent support base 20, three-layer structure having a medium refractive-index layer and a high refractive-index layer between the transparent support base 20 and the low refractive-index layer or a multilayer structure further having a hard-coat layer, a deformation layer, a vapor barrier layer layer, an antistatic layer, an undercoat layer and a protection layer. The coating equipment 22 is not limited to one using extrusion method shown in FIG. 1, but conventional coating equipments such as those using dip coating method, air knife coating method, curtain coating method, roller coating method, rod coating method and gravure coating method can be used. When an antireflection layer 24 having a structure of two or more layers is formed by coating, a single coating equipment 22 such as an extrusion die having a multi-manifold may be used to coat and form plural layers simultaneously or alternatively two or more coating dies each of which coats one layer are arranged to effect coating one after another. In addition, the method of forming an antireflection layer 24 on the transparent support base 20 is not limited to a coating method but any method mentioned in the related art section can also be used.

The drying equipment 26 may be either one using any drying system such as convection drying system by hot air, radiation drying system by radiant heat, and the system for conveying the antireflection film 30 in the drying equipment 26 may be either a contact conveying system such as those using rollers or a non-contact conveying system such as those using air or gas to make the film floated.

The antireflection film 30 formed in the antireflection film forming equipment 14 is then imparted with surface convexes and concaves by transferring convex-concave shapes on the surface of the antireflection layer 24 with the transfer equipment 16 and subsequently rolled up by the rolling-up equipment 18. Thus the antiglare and antireflection film 32 which is an antireflection film 30 having antiglare properties is produced. It should be noted that although a continuation process from the let-off equipment 12 to the rolling-up equipment 18 showed in FIG. 1, the antireflection film 30 formed in the antireflection film forming equipment 14 may once be rolled up in a roll with another rolling-up equipment (not illustrated) and the antireflection film 30 may be sent out from the rolling-up equipment to the transfer equipment 16.

The transfer equipment 16 is composed of an embossing roller 34 having a plurality of convexes and concaves on the roller surface which functions as a transfer surface and a backup roller 36 placed opposite to the embossing roller 34 as shown in FIG. 2. The diameters of the embossing roller 34 and the backup roller 36 are preferably in the range of 100 mmφ to 800 mmφ. While the both ends of the rotation axis 35 and 35 of the embossing roller 34 are rotatably supported by each of the shaft bearings 38 and 38, one end of the rotation axis 35 is connected with a motor 40. Each of the shaft bearings 38 and 38 of the embossing roller 34 is supported by the support stands 44 and 44 horizontally jutted out of a pair of supports 42 and 42 installed on the both sides in the direction the axis of the embossing roller 34. The backup roller 36 is arranged in adjacent and parallel with the embossing roller 34 under the latter, and while the both ends of the rotation axis 37 and 37 of the backup roller 36 are rotatably supported by each of the shaft bearings 46 and 46, one end of the rotation axis 37 is connected with a motor 48. Each of the shaft bearings 46 and 46 of the backup roller 36 is supported by the support stands 50 and 50 horizontally jutted out of a pair of the supports 42 and 42 and each of the support stands 50 is slidably attached in the perpendicular rail 52 through the linear bearing 54, which perpendicular rail 52 is provided on the side of the support 42. Furthermore, nut members 56 and 56 are incorporated with each of the support stands 50 and 50 approximately in the central part thereof, to which nut member 56 is screw fitted with a feeding screw 60 connected with a motor 58 which can rotate in the right and reverse direction. This configuration enables turning movement of the screw 60 by driving the motor 58 and movement of the backup roller 36 to and off the embossing roller 34, thereby enabling adjustment of the clearance between the embossing roller 34 and the backup roller 36 and the press load when the antireflection film 30 is nipped with the embossing roller 34 and the backup roller 36 screw 60. The size of the clearance and the press load are suitably set depending on the thickness of the antireflection film 30 to which the emboss processing is carried out, the shape of the convex and concave formed on the antireflection film 30 and the other emboss processing conditions. The clearance at the time of setting the clearance can be measured using a micrometer, a laser measuring instrument, etc. Although the embodiment of the present invention has been illustrated by an example in which the backup roller 36 is also provided with a motor 48, it should be noted that the backup roller 36 may be a driven roller.

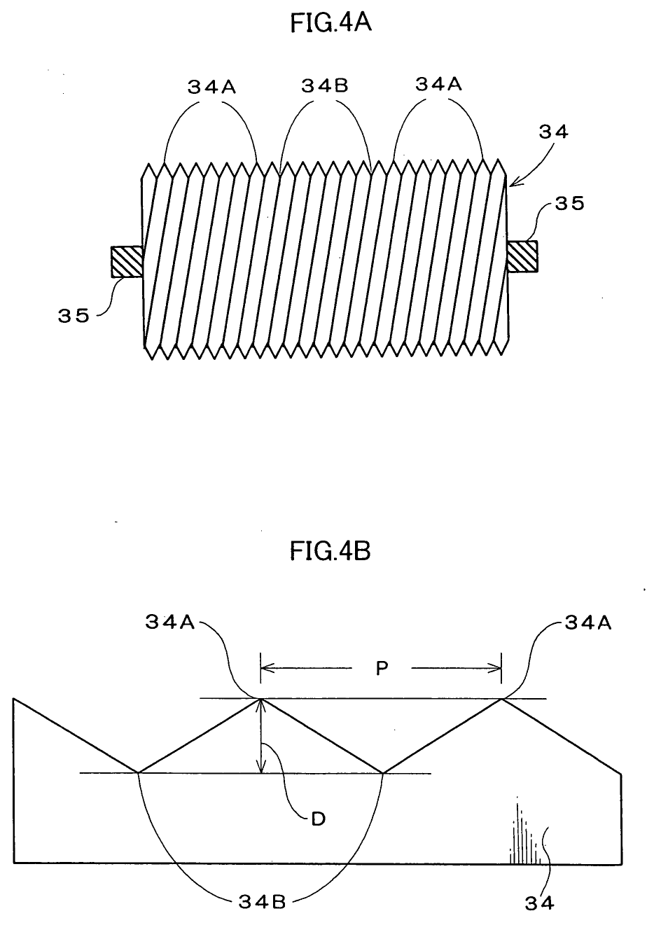

As shown in FIG. 3, the convexes and concaves formed on the antireflection film 30 by emboss processing have preferably an average pitch (P) between a surface convex 30A to the adjacent convex 30A in the range of 10 μm to 60 μm and more preferably in the range of 15 μm to 40 μm. The average depth (D) from the top of the convex 30A to the bottom of concave 30B is preferably in the range of 0.05 μm to 2 μm and more preferably in the range of 0.1 μm to 1 μm. Therefore, although the pitch size (P) and a depth size (D) of the convexes and concaves formed on the roll surface of the embossing roller 34 shown in FIG. 4A and FIG. 4B may vary depending on the antiglare and antireflection film 32 to be produced, it is preferable from the viewpoint of transfer accuracy that the average pitch (P) between a surface convex 34A to the adjacent convex 34A is in the range of 10 μm to 30 μm, and more preferably in the range of 10 μm to 15 μm and that the average depth (D) from the top of the convex 34A to the bottom of concave 34B is in the range of 0.3 μm to 1.5 μm, and more preferably in the range of 0.5 μm to 1 μm. Since the transferred convex-concave size will somewhat decrease after transfer due to the elasticity of the transparent support base 20, the pitch size (P) and depth size (D) of the convex-concave of the embossing roller 34 to be used may be actually 0% to 100% larger than the target average pitch (P) and the target average depth (D) to be transferred on the antireflection film 30 depending on the material of the transparent support base 20. In this case, the convex-concave structure by the emboss processing of the antireflection layer 24 may come out on the opposite side of the antireflection layer 24, but the rear surface of the antireflection film 30 after emboss processing does not need to be completely flat. Moreover, the shape of the convex 34A formed on the roll surface of the embossing roller 34 is preferably a part of rotation ellipse. As a method of forming the convexes and concaves on the roll surface of the embossing roller 34, various well-known methods such as photo lithography, machining, electrical discharge machining, laser processing, etc. can be adopted depending on the material of and the shapes to be formed on the embossing roller.

As for the backup roller 36, a roller with a longitudinal elastic modulus and pencil hardness of a roller smaller than the longitudinal elastic modulus and pencil hardness of the embossing roller 34 is used. That is, the longitudinal elastic modulus of the backup roller 36 is specified to be not less than 1×10⁴ kgf/cm² and not more than 2.1×10⁶ kgf/cm², more preferably specified to be not less than 1×10⁴ kgf/cm² and not more than 1.5×10⁵ kgf/cm². When prescribed by pencil hardness, the pencil hardness of the surface of the backup roller 36 is 2B or more and 7H or less, more preferably H or more and 5H or less. The condition may be specified with both the longitudinal elastic modulus and hardness. Although any material which satisfies these conditions of longitudinal elastic modulus and hardness can be used as a roller material, the roller made of a plastic, especially polyamide resin which has been subjected to hardening process (commonly known as MC nylon) and polyacetal resin can be preferably used.

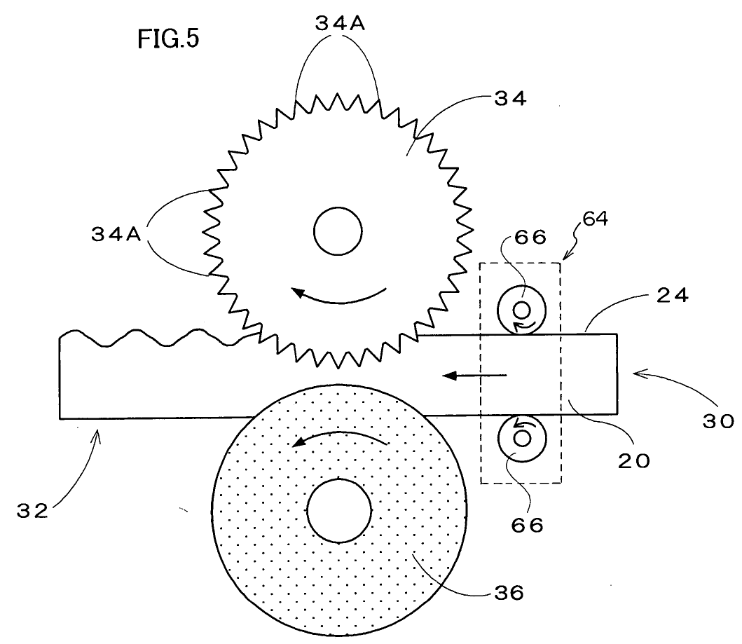

The longitudinal elastic modulus and hardness of the backup roller 36 is thus specified to be smaller than the longitudinal elastic modulus and hardness of the embossing roller 34, thereby as shown in FIG. 5, when the antireflection film 30 is nipped with the embossing roller 34 and the backup roller 36 to impart convexes and concaves to the surface of the antireflection layer 24, the pressure by which the convexes 34A of the embossing roller 34 depresses the backup roller 36 through the antireflection film 30 can be dispersed by the backup roller 36. This pressure dispersion prevents the convexes 34A of the embossing roller 34 from penetrating and perforating the antireflection film 30. Moreover, although transfer accuracy will be deteriorated if the longitudinal elastic modulus and hardness of the backup roller 36 are made excessively smaller, there is also no bad influence to the transfer accuracy by specifying the lower limit of the longitudinal elastic modulus to be 1×10⁴ kgf/cm², and specifying the lower limit of the pencil hardness of the surface of the backup roller 36 to be 2B. As other conditions in this transfer operation, the pressure of the press (linear pressure) by which the antireflection film 30 is nipped with the embossing roller 34 and the backup roller 36 may be suitably 100 kgf/cm to 3000 kgf/cm, and more preferably 500 kgf/cm to 1500 kgf/cm. Therefore, the clearance of the embossing roller 34 and the backup roller 36 and the press load may be advantageously adjusted depending on the thickness of the antireflection film 30 so that this pressure of the press may be obtained. In this case, it is more advantageous that the press load is measured by a load measuring instruments 39 such as a load cell as shown in FIG. 2, the relationship between the press load and the perforation of the antireflection film 30 and transfer accuracy is grasped and the clearance and press load is adjusted based on the obtained information. Transfer processing rate is suitable in the range of 0.1 m/min to 50 m/min, and more preferably in the range of 1 m/min to 20 m/min.

It is also preferable to emboss processing the antireflection film 30 in the state where the roller surface temperature of the embossing roller 24 and the backup roller 36 is heated higher than the glass transition temperature of the transparent support base 20. This enables occurrence of wrinkles on the rollers 34 and 36 by heat expansion of the transparent support base 20 to be controlled, and the antireflection film 30 without wrinkles can be produced by emboss processing. The heating device for attaining such temperature conditions is not particularly illustrated, but may be comprised of, for example, water-conducting pipes built in through the rollers of the embossing roller 34 and the backup roller 36 respectively, which pipes are connected with heat medium supply equipment respectively through rotary joint. The roller surface temperature of the embossing roller 34 and the backup roller 36 is warmed above the glass transition temperature of the transparent support base 20 by circulating the heat media such as warm water between the rollers and the supply equipment. As the upper limit of the roller surface temperature of the embossing roller 34 or the backup roller 36, glass transition temperature of the transparent support base 20 to be used +50° C. is preferable. It should be noted that, the heating device is not limited to a medium circulation system and induction heating and other heating methods can be used.

As shown in FIG. 1 and FIG. 5, it is still better to provide preliminary heating device 64 which preliminarily heats the antireflection film 30 beforehand at a upstream position in the conveyance direction of the antireflection film 30 from the position of the embossing roller 34 and the backup roller 36. The preliminary heating device 64 is not limited but a pair of roll heaters 66 and 66 can be preferably used. The pair of roll heaters 66 and 66 which nip and convey the antireflection film 30 while conducting the heating thereof not only enable the transparent support base 20 of the antireflection film 30 to be preliminarily heated higher than the glass transition temperature but also press the antireflection layer 24 beforehand prior to the transfer of the convex-concave structure thereby improve the transfer accuracy.

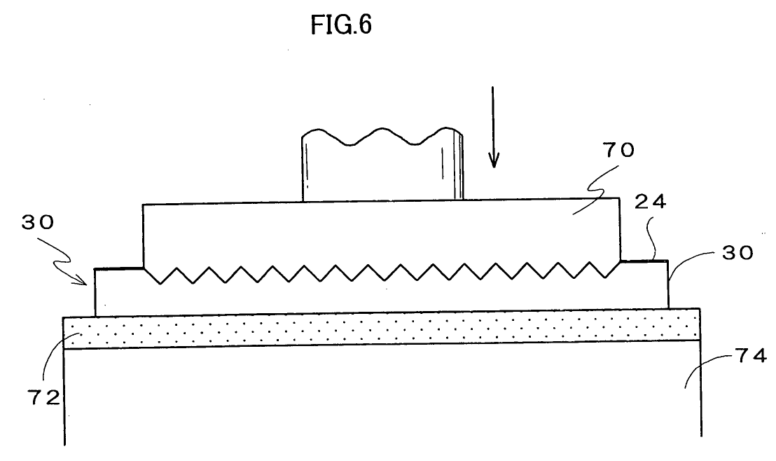

According to the method for producing an antiglare and antireflection film of the present invention, the transfer operation to the antireflection film 30 is not limited to once but the film may be passed through transfer equipment 16 two or more times. In this case, continuation transfer can be performed if a series of transfer equipments 16 are provided. Although an embodiment of the present invention as a transfer equipment 16 has been described in a continuous system where a belt-like antireflection film 30 is continuously passed between the embossing roller 34 and the backup roller 36 to conduct emboss processing, a batch system where a single leaf-like antireflection film 30 is nipped with the embossing roller 34 and the backup roller 36 one by one may be used. In the case of this batch system, another construction can also be used where the embossing roller 34 and the backup roller 36 is replaced with a pattern plate 70 having a lot of convexes and concaves formed on the transfer surface as shown in FIG. 6, and a flat support member 72 which has the same longitudinal elastic modulus and same hardness as the backup roller 36 as mentioned above is placed on the support stand 74 in a position facing the pattern plate 70 and the single leaf-like antireflection film 30 is pressed by the pattern plate 70 and the support member 72.

Preferable constitution of the transparent support base 20 and the antireflection layer 24 in the present invention will be described below.

As a transparent support base 20 used in the present invention, it is preferable to use a plastic film of the thickness of about 50 μm to 100 μm. Example of the material of such a plastic film include cellulose esters (for example, triacetyl cellulose, diacetyl cellulose, propionyl cellulose, butyril cellulose, acetylpropionyl cellulose, nitrocellulose), polyamides, polycarbonates, polyesters (for example, polyethylene terephthalate, polyethylene naphthalate, poly-1,4-cyclohexane dimethylene terephthalate, polyethylene-1,2-diphenoxyethane-4,4′-dicarboxylate, polybutylene terephthalate), polystyrenes (for example, syndiotactic polystyrene), polyolefines (for example, polypropylene, polyethylene, polymethylpentene), polysulfones, polyethersulfones, polyarylate, polyetherimide, polymethylmethacrylate, polether ketones and the like. Among these, triacetyl cellulose, polycarbonate and polyethylene terephthalate are preferable. The light transmittance of the transparent support base 20 is preferably 80% or more, more preferably 86% or more. That haze of the transparent support base 20 is 2.0% or less, more preferably 1.0% or less. The refractive index of the transparent support base 20 is preferably from 1.4 to 1.7.

The refractive index of the lower refractive-index layer in the antireflection layer 24 is preferably from 1.20 to 1.55, more preferably from 1.30 to 1.55. The refractive index of the higher refractive-index layer is preferably from 1.65 to 2.40, more preferably from 1.70 to 2.20. The refractive index of the medium refractive-index layer is adjusted to be a value between that of the lower refractive-index layer and that of the higher refractive-index layer. The refractive index of the medium refractive-index layer is preferably from 1.55 to 1.80.

As the lower refractive-index layer, a porous layer comprising inorganic particles and an organic polymer, and a layer of a fluorine-containing polymer may be preferably used. The thickness of the lower refractive-index layer is advantageously from 50 nm to 400 nm, and more preferably from 50 nm to 200 nm. When a porous layer comprising inorganic particles and an organic polymer is used, the surface of inorganic particles can be modified to improve adhesion with the organic polymer, and the organic polymer can be prepared using a monomer, polymer, or a mixtures thereof which can be crosslinked by heat or ionization radiation, thereby the lower refractive-index layer excellent in film intensity can be obtained. When a fluorine-containing polymer is used, a polymer having a high fluoride content or a polymer having a large free volume are preferable from the viewpoint of a low refractive index and a crosslinkable polymer is preferable from the viewpoint of adhesion. As for the type of the crosslinking, a heat curing type polymer and an ionization radiation curing type polymer are commercially available.

A higher refractive-index layer may be provided between the lower refractive-index layer and the transparent support base 20, and a medium refractive-index layer may be provided between the higher refractive-index layer and the transparent support base 20. The refractive index of the higher refractive-index layer is preferably from 1.65 to 2.40, more preferably from 1.70 to 2.20. The refractive index of the medium refractive-index layer is adjusted to be a value between the refractive index of the lower refractive-index layer and the refractive index of the higher refractive-index layer. The refractive index of the medium refractive-index layer is preferably from 1.55 to 1.80. The medium refractive-index layer and the higher refractive-index layer are preferably formed using a polymer having a relatively high refractive index. Example of polymers having a high refractive index include polystyrene, styrene copolymer, polycarbonate, melamine resin, phenol resin, epoxy resin, and polyurethane obtained at the reaction of a cyclic (alicyclic or aromatic) isocyanate and the polyol. Polymers having the other cyclic (aromatic, heterocyclic, alicyclic) groups and polymers having a halogen atom other than fluorine as a substitution group also have a high refractive index. The polymer may be formed by the polymerization reaction of monomers to which a double bond has been introduced so that radical curing may occur.

The antireflection film may further include a hard-coat layer, a deformation layer, a vapor barrier layer layer, an antistatic layer, an undercoat layer, and a protection layer. The hard-coat layer is provided in order to impart anti-bruise properties to the transparent support base. The hard-coat layer also has a function to strengthen the adhesion between the transparent support base and the layers thereon. The hard-coat layer can be formed using an acrylate based polymer, an urethane based polymer, an epoxy based polymer, or a silica based compound. A pigment may be added in the hard-coat layer. As a material used for the hard-coat, polymers having a saturated hydrocarbon or a polyether as a main chain are preferable, and polymers having a saturated hydrocarbon as a main chain are more preferable, and polymers having crosslinked structures are preferable. The polymers having a saturated hydrocarbon as a main chain may be preferably obtained by the polymerization reaction of ethylenically unsaturated monomers. For the purpose of constructing a crosslinked polymer, monomers having two or more ethylenically unsaturated groups may be preferably used. Example of such monomers having two or more ethylenically unsaturated groups include esters of a polyol and (meth)acrylic acid (for example, ethyleneglycol di(meth)acrylate, 1,4-cyclohexane diacrylate, pentaerythrithol tetra(meth)acrylate, pentaerythrithol tri(meth)acrylate, trimethylolpropane tri(meth)acrylate, trimethylolethane tri(meth)acrylate, dipentaerythrithol tetra(meth)acrylate, dipentaerythrithol penta(meth)acrylate, pentaerythrithol hexa(meth)acrylate, 1,2,3-cyclohexane tetrametacrylate, polyurethane polyacrylate, polyester polyacrylate), vinylbenzene and derivatives thereof (for example,1,4-divinylbenzene, 4-vinylbenzoic acid-2-acryloyl ethylester,1,4,-divinylcyclohexanone), vinylsulfones (for example, divinylsulfone), acrylamides (for example, methylenebisacrylamide) and methacrylamides.

Instead of the monomers having two or more ethylenically unsaturated groups, or in addition to them, a crosslinking structure may be introduced by the reaction of crosslinkable groups. Examples of crosslinkable groups include isocyanate group, epoxy group, aziridine group, oxazoline group, aldehyde group, carbonyl group, and hydrazine anoacrylate derivatives, melanine, etherized methylol, esters and urethanes can be also used as monomers for introducing the crosslinking structure. Functional groups which show a crosslinkable nature as a result of decomposition reaction such as a block isocyanate group may be used. It should be noted that the crosslinkable groups in the present invention are not restricted to the above-mentioned compounds and may be those which show a reactive nature as a result of decompositions of the above-mentioned groups. The hard-coat layer is preferably formed by dissolving a monomer and a polymerization initiator and conducting the polymerization reaction (and also crosslinking reaction if required) after the solvent is applied. As the polymerization initiator, hydrogen drawing-out types such as benzophenone based compounds, radical cleaving types such as acetophenone based or triazine based compounds singularly or in combination may be used and preferably added to the coating liquid with a monomer. The coating liquid of the hard-coat layer may contain a small amount of polymer (for example, a poly(methyl methacrylate), poly(methyl acrylate), diacetyl cellulose, triacetyl cellulose, nitrocellulose, polyester, alkid resin).

A protection layer may be provided on the lower refractive-index layer. The protection layer functions as a slipping layer or a dirt prevention layer. Example of the slipping agent used for the slipping layer include polyorganosiloxanes (for example, polydimethylsiloxane, polydiethylsiloxane, polydiphenylsiloxane, polymethylphenylsiloxane, alkyl-modified polydimethylsiloxane), natural wax (for example, carnauba wax, candelilla wax, jojoba oil, rice wax, Japanese wax, honey wax, lanolin, spermaceti wax, montan wax), petroleum wax (for example, paraffine wax, microcrystalline wax), synthetic wax (for example, polyethylene wax, Fischer-Tropsch wax) and higher fatty acid amides (for example, stearamide, oleinamide, N,N′-methylenebis stearamide), higher fatty acid esters (for example, methyl stearate, buthyl stearate, glycerin monostearate,sorbitan monooleate), higher fatty acid metal salt (for example, zinc stearate), and fluorine-containing polymer (for example, perfluoro-main-chain-type perfluorpolyether, perfluoro-side-chain-type perfluorpolyether, alcohol modified perfluorpolyether, and isocyanate modified perfluorpolyether). A fluorine-containing hydrophobic compound (for example, fluorine-containing polymer, fluorine-containing surfactant, fluorine-containing oil) is added to the dirt prevention layer. The thickness of the protection layer is preferably 20 nm or less in order not to affect antireflection function.

Furthermore in the present invention, a deformation layer may be provided between the transparent support base and the hard-coat layer. Since the hard-coat layer may hardly plastically deform, concavo-convex formation will be made by plastic deformation of the transparent support base, but a polymer layer consisting of a (meth)acrylic acid ester which deforms more readily than the transparent support base may be provided between the transparent support base and the hard-coat layer thereby increasing plastic deformation and as a result allowing the surface convexes and concaves to be more readily formed. This deformation can be performed using not only pressure but also pressure and heat. The plastic deformation can be further promoted by carrying out at a temperature higher than the glass transition temperature of the acrylic acid ester. Moreover, the glass transition temperature of the polymer can be optionally adjusted by changing the structure of the ester part of this (meth)acrylic acid ester, and the glass transition temperature is preferably between the room temperature and 140° C. to 200° C. which is common as the glass transition temperature of the transparent support base, and specifically the range from 80° C. to 110° C. is preferable. This is because the hard-coat nature of the antireflection film 30 is not deteriorated since it is smaller at room temperature than the glass transition temperature and only plastic deformation of the deformation layer can be promoted without changing the optical and dynamics physical properties at the time of concavo-convex formation.

Specific examples of (meth)acrylic acid esters include homopolymers or copolymers of methyl (meth)acrylate, an ethyl (meth)acrylate, butyl (meth)acrylate, (meth)acrylic acid, glycidyl (meth)acrylate and hydroxyethyl (meth)acrylate and the like. Low molecular compounds such as a surface-active agent and other polymers may be used for improving coating properties and adhesion with the transparent support base and adjusting the glass transition temperature. Examples of these polymers include water-soluble polymers such as gelatin, poly vinyl alcohol, and polyalginic acid (salt) as well as cellulose esters (for example, triacetyl cellulose, diacetyl cellulose, propionyl cellulose, butyryl cellulose, acetylpropionyl cellulose, nitrocellulose, hydroxyethyl cellulose, hydroxypropyl cellulose), polystyrenes, polyetherketones and copolymers thereof. The glass transition temperature of the thus formed deformation layer may preferably have from 60° C. to 130° C., more preferably from 80° C. to 110° C.

### Embodiment

After an antireflection layer having a thickness of 100 nm as dried film was applied and formed on a triacetyl cellulose film of 80 μm and dried at 120° C., heat curing was conducted to form an antireflection film. The antireflection film was nipped with a metal embossing roller 34 of 100 mmφ and a backup roller 36 of 100 mmφ made of MC nylon, thereby transferring the convex-concave shape formed on the roll surface of the the embossing roller 34 to the antireflection film. The convex-concave pitch size (P) of the embossing roller 34 was set to be 15 μm, and the depth size (D) to 0.8 μm. Transfer processing speed in this transfer operation was set to be 1 m/min and the roll surface temperature of the embossing roller 34 to 150° C. The clearance between the embossing roller 34 and the backup roller 36 was set to 0.05 mm and the pressure of the press (linear pressure) to 500 kgf/cm.

Existence of perforation to the antireflection film and transfer accuracy were evaluated at the time of changing the longitudinal elastic modulus of the backup roller 36 (kgf/cm²).

Consequently, if the longitudinal elastic modulus of the backup roller is in the range of not less than 1×10⁴ kgf/cm² and not more than 2.1×10⁶ kgf/cm², no perforation to the antireflection film occurred and there was also observed good transfer accuracy. On the contrary, if the longitudinal elastic modulus of the backup roller exceeds 2.1×10⁶ kgf/cm², some perforations to the antireflection film were observed. If the longitudinal elastic modulus of the backup roller is less than 1×10⁴, transfer accuracy was deteriorated.

Similarly the pencil hardness of the surface of the backup roller 36 was changed, and existence of perforation to the antireflection film and transfer accuracy were evaluated, and if the pencil hardness of the surface of the backup roller 36 is not less than 2B and not less than 7H, no perforation to the antireflection film occurred and there was also observed good transfer accuracy. On the contrary, if the pencil hardness on the surface of the backup roller exceeds 7H, some perforations to the antireflection film were observed and if the pencil hardness was less than 2B, transfer accuracy was deteriorated.

What is claimed is:

1. A method for producing an antiglare and antireflection film, comprising the step of:
nipping the antireflection film with an embossing member having a plurality of convexes and concaves and a support member to transfer the shape of convexes and concaves of the embossing member to the surface of the antireflection layer after providing at least one antireflection layer on a transparent support base to form an antireflection film,
wherein when the antireflection film is nipped with the embossing member and the support member, the pressure applied on the support member by the convex portions through the antireflection film is dispersed by the support member.

2. An equipment for producing an antiglare and antireflection film, comprising
an equipment for forming an antireflection film by providing at least one antireflection layer on a transparent support base to form an antireflection film; and
an equipment for transferring which nips the antireflection film with an embossing member and a support member to transfer the shape of convexes and concaves of the embossing member to the surface of the antireflection layer,
wherein the support member has a longitudinal elastic modulus or pencil hardness less than the longitudinal elastic modulus or pencil hardness of the embossing member.

3. The equipment for producing an antiglare and antireflection film according to claim 2, wherein the support member has a longitudinal elastic modulus of not less than 1×10⁴ kgf/cm² and not more than 2.1×10⁶ kgf/cm².

4. The equipment for producing an antiglare and antireflection film according to claim 2, wherein the surface layer of the support member has a pencil hardness of 2B or more 7H or less.

5. The equipment for producing an antiglare and antireflection film according to claim 2, wherein a heating device is provided for heating at least the surface of the embossing member out of the embossing member and the support member to a temperature above the glass transition temperature of the transparent support base.

6. The equipment for producing an antiglare and antireflection film according to claim 2, wherein the embossing member is an embossing roller and the support member is a backup roller.

7. The equipment for producing an antiglare and antireflection film according to claim 2, wherein the equipment for forming an antireflection film is a coating equipment.

8. An antiglare and antireflection film produced by using the equipment for producing an antiglare and antireflection film of claim 2.
